(19) United States
(12) Patent Application Publication
(10) Pub. No.: US 2019/0145899 A1
(43) Pub. Date: May 16, 2019

(54) PIPETTE TYPE WITH INTERIOR SURFACE ENHANCED LUMINESCENCE STAGE

(71) Applicant: Hewlett-Packard Development Company, L.P., Houston, TX (US)

(72) Inventors: Viktor Shkolnikov, Palo Alto, CA (US); Anita Rogacs, San Diego, CA (US)

(73) Assignee: Hewlett-Packard Development Company, L.P., Houston, TX (US)

(21) Appl. No.: 16/098,100

(22) PCT Filed: Jul. 22, 2016
(86) PCT No.: PCT/US2016/043472

§ 371 Date: Oct. 31, 2018

(51) Int. Cl. G01N 21/65; B01L 3/02; G01N 21/64; G01J 3/44

(52) U.S. Cl. CPC G01N 21/658; B01L 3/0275; G01N 21/648; B01L 2300/168; B01L 2200/143; B01L 2300/0654; G01J 3/44

(57) ABSTRACT

An apparatus may include a surface enhanced luminescence (SEL) stage on an interior of a pipette tip.

### BACKGROUND

Surface enhanced luminescence (SEL) is sometimes used for analyzing the structure of inorganic materials and complex organic molecules. SEL focuses electromagnetic radiation or light onto an analyte, wherein the interaction between the light and the analyte is detected for analysis.

### BRIEF DESCRIPTION OF THE DRAWINGS

FIG. 1 is a sectional view of an example SEL pipette tip (SPT).

FIG. 2 is a flow diagram of an example method for preparing an analyte for sensing using an example SPT.

FIG. 3 is a sectional view illustrating the drawing of a solution into a pipette tip of the example SPT of FIG. 1.

FIG. 4 is a sectional view illustrating the dispensing of the solution out of the pipette tip of the example SPT of FIG. 1.

FIG. 5 is a sectional view of an example SPT.

FIG. 6 is a sectional view of the example SPT of FIG. 5 taken along line 6-6, illustrating first example focusing lenses.

FIG. 7 is a sectional view of the example SPT of FIG. 5 taken along line 6-6, illustrating second example focusing lenses.

FIG. 8 is a sectional view of the example SPT of FIG. 5 taken along line 6-6, illustrating a third example focusing lenses.

FIG. 9 is a sectional view of the example SPT of FIG. 5 taken along line 6-6, illustrating a fourth example focusing lenses.

FIG. 10 is a side view of an example pipette system including interchangeable SPTs.

FIG. 11 is a sectional view of an example SPT having nano fingers.

FIG. 12 is a flow diagram of an example method for preparing a solution for testing using the example SPT of FIG. 11.

FIG. 13 is a sectional view of the example SPT of FIG. 11 illustrating drawing of solution into the SPT and the dispensing a solution from the SPT.

FIG. 14 is a sectional view of the example SPT of FIG. 11 illustrating the drawing in of air and dispensing of air from the SPT to accelerate drying and closing of the nano fingers.

FIG. 15 is a side view of an example pipette sensing system.

FIG. 16 is an enlarged view of a portion of the example pipette sensing system of FIG. 15.

FIG. 17 is a flow diagram of an example method for controlling sensing by the example pipette sensing system of FIG. 15.

FIG. 18 is a sectional view schematically illustrating an example sensing station.

FIG. 19 is an enlarged fragmentary top view illustrating one example keying of an example SPT in an example well of the sensing station of FIG. 18.

FIG. 20 is a top view schematically illustrating an example layout of wells for the example sensing station of FIG. 18.

FIG. 21 is a side view schematically illustrating an example sensing station.

### DETAILED DESCRIPTION OF EXAMPLES

In many chemical and biological endeavors, solution containing analyte are transferred using pipette tips. Analysis of the solution being transferred and/or its analytes may involve dispensing a portion of the solution onto a separate testing apparatus. Such a procedure requires additional equipment, consumes valuable time and increases cost.

In chemical and biological research and development operations, reagents may be transferred by pipette tips. However, little or no quality control is done to ensure the properties of the reagents being transferred. Doing so might lengthen workflow and cost. Failing to do so may lead to incorrect results, wasted reagents, wasted time and additional cost.

The present disclosure describes various examples of SEL pipette tips, pipette dispensers and systems that facilitate the testing of the solutions within the SEL pipette tips. The present disclosure describes an example pipette tip having a surface enhanced luminescence (SEL) stage that facilitates testing of solution that is or has been transferred by the pipette tip. The present disclosure describes an example pipette dispenser that facilitates SEL testing using the pipette tip. The present disclosure describes examples of systems for preparing the SEL stage for sensing and carrying out sensing of the solution on the SEL stage. The present disclosure describes various methods for carrying out SEL sensing using the SEL stage.

FIG. 1 is a sectional view of an example SEL pipette tip (SPT) 20. SPT 20 facilitates the transfer of a liquid or solution containing an analyte while also serving as a platform for staging the analyte for sensing. SPT 20 comprises pipette tip 24 and SEL stage 28. Pipette tip 24 comprises an elongate tubular member having a first end portion 32, a middle portion 34 and a second end portion 36. End portion 32 is to releasably mount to a pipette dispenser.

In one implementation, pipette tip 24 as an internal shape and size to facilitate and portion 32 being press-fit onto a pipette dispenser. In one implementation, end portion 32 receives a portion of the pipette dispenser and a slightly smaller than the received portion of the pipette dispenser to provide an interference fit. In another implementation, end portion 32 may be shape, size or dimension to be received within a portion of a pipette dispenser. In other implementations, in lieu of an interference fit being formed between the pipette dispenser and the pipette, other mechanisms may be employed to releasably connect or join the end portion 32 to the pipette dispenser.

Middle portion 36 extends between portions 32 and 34. In the example illustrated, middle portion 36 has a uniform inner diameter and the uniform outer diameter. In other implementations, the outer diameter and/or shape of middle portion 36 may be different than the inner diameter and/or shape of middle portion 36.

End portion 36 is located at an opposite end of pipette tip 24 as end portion 32. In the example illustrated, and portion 36 tapers from a middle portion 36 to the port 40 located at the tip of pipette tip 24. The taping of end portion 36 facilitates precise control over the quantity of liquid being aspirated into tip 24 and dispensed from tip 24. The taping of end portion 36 further facilitate acquisition and dispensing of liquid or solution with respect to smaller size sources and receivers of the solution.

In one implementation, port 40 has a diameter of less than or equal to 3 mm. In other implementations, port 40 may have other opening dimensions. In one implementation, the tapering portion of pipette tip 24, forming end portion 36, has a length of at least 1 mm and no greater than 10 cm. In other implementations, end portion 36 may have other lengths. In one implementation, middle portion 34 has an inner diameter of at least 2 mm and no greater than 2 cm. In other implementations, middle portion 34 may have other inner diameters. In one implementation, pipette tip 24 is an overall length of at least 2 cm and no greater than 20 cm. In other implementations, pipette tip 24 may have other lengths. In one implementation, pipette tip 24 as an overall internal volume for containing liquid (when mounted to pipette dispenser) of at least 0.1 ul and no greater than 50 mL. In other implementations, pipette tip 24 may have other internal volumes. In other implementations, port 40 may have other opening dimensions.

SEL stage 28 comprises a surface enhanced luminescence analyte stage upon which analyte is deposited for testing. For purposes of this disclosure, a surface enhanced luminescence (SEL) analyte stage is any structure or particle that interacts with the deposited analyte so as to enhance the intensity of the radiation scattered or reemitted by the analyte. Stage 28 enhances the amount of radiation or the number of photons that are scattered or re-emitted by the analyte upon being impinged by radiation from a radiation source.

In one implementation, the SEL structures comprise enhanced fluorescence spectroscopy structures or enhanced luminescence spectroscopy structures. In one implementation, the SEL structures comprise surface enhanced Raman spectroscopy (SERS) structures. Such structures may include a metal surface or structure, wherein interactions between the analyte and the metal surface cause an increase in the intensity of the Raman-scattered radiation. Such metal surfaces may include a roughened metal surface or metal islands. In one implementation, such metal islands comprise columnar supports such as pillars, needles, fingers, particles or wires. In some implementations, the columnar structures may include a metal cap or head upon which analyte may be deposited. In some implementations, such columnar structures are formed from materials and/or are dimensioned so as to bend or flex towards and away from one another in response to applied electric fields. In some implementations, the SEL structures are movable, wherein such columnar structures bend or flex towards one another in response to micro-capillary forces, wherein such bending facilitates close spacing between the structures for greater scattered radiation intensity.

In one implementation, the SEL or SER structures have a nanometer scale to facilitate nano-enhanced Raman spectroscopy (NERS). Such nano-scale NERS structures may increase the intensity of radiation scattered by the analyte adsorbed on such structures by many orders of magnitude. In one implementation, such structures comprise nano fingers. In other implementations, stage 28 may comprise SEL particles. Examples of SEL particles include, but are not limited to, electrodes in electrolytic cells and metal colloid solutions.

In one implementation, stage 28 comprises an SEL structure or a group of SEL structures supported by a die or substrate that is mounted to pipette tip 24 within the interior of pipette tip 24. In one implementation, stage 24, supported by substrate, is formed outside of pipette tip 24 and is mounted within pipette tip 24. In another implementation, stage 28 is formed directly on the interior surface of pipette tip 24. For example, in some implementations, the SEL particles maybe adhered directly to the interior surface of pipette tip 24. In some implementations, the SEL structures, such as nano fingers, may be directly formed upon the interior surface of pipette tip 24. In some implementations, nano fingers maybe imprinted or molded on the interior surface of pipette tip 24.

SEL stage 28 is located within pipette tip 24 so as to be immersed in the solution or liquid drawn into pipette tip 24 In the example illustrated, SEL stage 28 is located within middle portion 34 of pipette tip 24. As indicated by broken lines, in other implementations, SEL stage 28 may be located within the tapered end portion 36 of pipette tip 24.

Regardless of where located within the body of pipette tip 24, SEL stage 28 is located sufficiently adjacent a portion of pipette tip 24 that is transparent to the light to be used to interact with the solution or analyte on stage 28 during testing. In one implementation, selected portions of the outer wall of middle portion 34 (or the outer wall of end portion 36) are formed from material or materials that are transmissive with respect to light that is to interact with the analyte on stage 28. For example, as indicated by broken lines in FIG. 1, in some implementations, portions of pipette tip 24 may include a solid light transmissive window 38 formed from a different material as compared to the remainder of pipette tip 24, wherein the window is sized to permit a sufficient surface area stage 28 to be illuminated for testing.

In some implementations, the portion of pipette tip 24 containing stage 28 may be entirely formed from the light transmissive material. For example, the entire cylindrical wall of middle portion 34 may be formed from a light transmissive material, whereas end portion 32 and end portion 36 are formed from other, not necessarily light transmissive materials or whereas end portion 32 and/or end portion 36 may have surface shapes, textures or the like that impede the transmission of light. In other implementations, and in the example illustrated, an entirety of pipette tip 24 is formed from the same light transmissive material, wherein at least those portions of pipette tip 24 that are proximate to stage 28 are sufficiently smooth and clear for the transmission of light.

In one implementation, the entirety of pipette tip 24 is formed from a polymer. In one implementation, the entirety of pipette tip 24 is formed from a material selected from a group of materials consisting of polypropylene. In implementations where stage 28 is located within middle portion 34, middle portion 34 is formed from such materials, whereas other portions of pipette tip 28 are formed from other materials. In some implementations, window 38 may be formed from such materials. Likewise, in implementations where stage 28 is located within portion 36, portion 36 is formed from such light transmissive materials while other portions of pipette tip 24 are formed from other materials. In still other implementations that include the aforementioned window 38, window 38 is formed from such light transmissive materials.

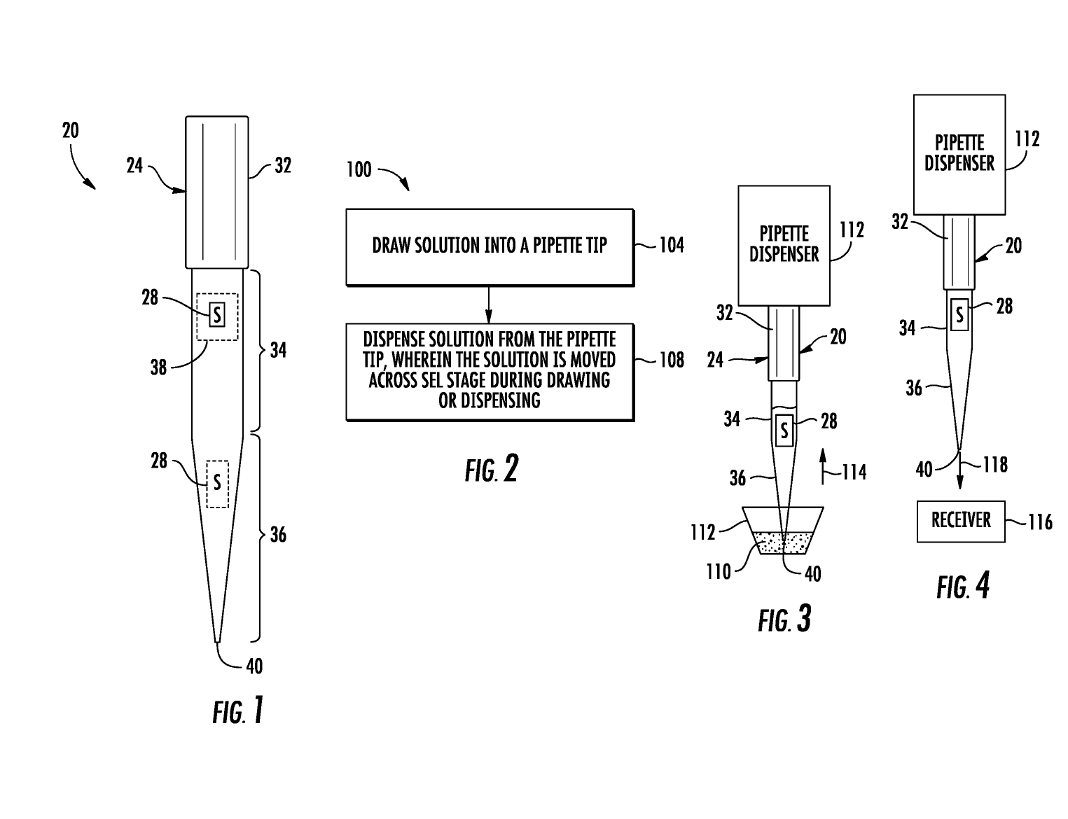

FIG. 2 is a flow diagram of an example method 100 for preparing a solution for SEL sensing using a SEL pipette tip. FIGS. 3 and 4 illustrate method 100 being carried out. Although method 100 is described with respect to the use of SPT 20 shown and described above with respect to FIG. 1, it should be appreciated that method 100 may be carried out using other SEL pipette tips, such as any of the other SEL pipette tips described hereafter.

As indicated by block 104 in FIG. 2 and illustrated in FIG. 3, solution 110 is drawn into SEL pipette tip 20. In one implementation, the plunger associated with pipette dispenser 112 (schematically shown) is withdrawn to draw solution 110 (contained in supply 112) in the direction indicated by arrow 114 through port 40 and into the interior of pipette tip 24. As indicated by block 108 and illustrated in FIG. 4, the solution within pipette tip 24 is dispensed into or onto a receiver 116 in the direction indicated by arrow 118. In one implementation, the plunger associated with pipette dispenser 112 is driven towards port 40 to dispense a solution through the port 40. During the drawing or aspiration of the solution into the interior of pipette tip 24 and during the dispensing of the solution out of pipette tip 24 through port 40, the solution is moved across SEL stage, with the analyte contained within the solution coating SEL stage 28. In implementations were SEL stage 28 comprises a surface enhanced Raman spectroscopy stage, the remaining solution coating SEL stage 28 is dried or allowed to evaporate, readying the remaining analyte on stage 28 for being sensed using SEL.

FIGS. 5 and 6 illustrate an example SEL pipette tip (SPT) 220. SPT 220 is similar to SPT 20 except that SPT 220 comprises SEL stages 228A, 228B, 228C and 228D (shown in FIG. 6) (collectively referred to as stages 228), focusing lenses 242A, 242B, 242C and 242D (shown in FIG. 6) (collectively referred to as lenses 242) and graduations 244. Those remaining components or elements of SPT 220 which correspond to components or elements of SPT 20 are numbered similarly.

Stages 228 are each individually similar to stage 28 described above. comprises a surface enhanced luminescence analyte stage upon which analyte is deposited for testing. As with stage 28, each of stages 228 enhances the amount of radiation or the number of photons that are scattered or re-emitted by the analyte upon being impinged by radiation from a radiation source.

In one implementation, the SEL structures of stages 228 comprise enhanced fluorescence spectroscopy structures or enhanced luminescence spectroscopy structures. In one implementation, the SEL structures comprise surface enhanced Raman spectroscopy (SERS) structures. Such structures may include a metal surface or structure, wherein interactions between the analyte and the metal surface cause an increase in the intensity of the Raman-scattered radiation. Such metal surfaces may include a roughened metal surface or metal islands. In one implementation, such metal islands comprise columnar supports such as pillars, needles, fingers, particles or wires. In some implementations, the columnar structures may include a metal cap or head upon which analyte may be deposited. In some implementations, such columnar structures are formed from materials and/or are dimensioned so as to bend or flex towards and away from one another in response to applied electric fields. In some implementations, the SEL structures are movable and are self-actuating, wherein such columnar structures bend or flex towards one another in response to micro-capillary forces so as to self-organize, wherein such bending facilitates close spacing between the structures for greater scattered radiation intensity.

In one implementation, the SEL or SER structures of stages 228 have a nanometer scale to facilitate nano-enhanced Raman spectroscopy (NERS). Such nano-scale NERS structures may increase the intensity of radiation scattered by the analyte adsorbed on such structures by many orders of magnitude. In one implementation, such structures comprise nano fingers. In other implementations, each of stages 228 may comprise SEL particles. Examples of SEL particles include, but are not limited to, electrodes in electrolytic cells and metal colloid solutions.

In one implementation, each of stages 228 comprises an SEL structure or a group of SEL structures supported by a die or substrate that is mounted to pipette tip 24 within the interior of pipette tip 24. In one implementation, stage 24, supported by substrate, is formed outside of pipette tip 24 and is mounted within pipette tip 24. In another implementation, stage 28 is formed directly on the interior surface of pipette tip 24. For example, in some implementations, the SEL particles maybe adhered directly to the interior surface of pipette tip 24. In some implementations, the SEL structures, such as nano fingers, may be directly formed upon the interior surface of pipette tip 24. In some implementations, nano fingers maybe imprinted or molded on the interior surface of pipette tip 24.

Each of stages 228 is located within pipette tip 24 so as to be immersed in the solution or liquid drawn into pipette tip 24. In the example illustrated, SEL stages 228A, 228B and 228C are located at different spaced locations along the centerline or axis 245 of pipette tip 24. SEL stage 242A is proximate to end portion 32, while SEL stage 228B is located between SEL stage 228A and port 40. SEL stage 228C is located between SEL stage 228 B and port 40, within end portion 36. As shown by FIG. 6, SEL stage 228D is located at a same axial location as SEL stage 228A, but is circumferentially offset from SEL stage 228A. In the example illustrated, SEL stage 228D is circumferentially offset 90 degrees from SEL stage 228A to facilitate illumination of each of the stages through offset portions of the tubular wall 246 of pipette tip 24. In other implementations, SPT 220 may include additional or fewer of such SEL stages 228. For example, SPT 220 may comprise additional actually space stages 228 and/or may comprise additional SEL stages a different angular positions circumferentially spaced about the centerline 245.

As with SPT 20, each SEL stage 228 is located sufficiently adjacent a portion of pipette tip 24 that is transparent to the light to be used to interact with the solution or analyte on stage 228 during testing. In one implementation, selected portions of the outer wall of middle portion 34 (or the outer wall of end portion 36) are formed from material or materials that are transmissive with respect to light that is to interact with the analyte on stage 228. For example, as indicated by broken lines in FIG. 1, in some implementations, portions of pipette tip 24 may include a solid light transmissive window 38 formed from a different material as compared to the remainder of pipette tip 24, wherein the window is sized to permit a sufficient surface area of each of stages 228 to be illuminated for testing.

In some implementations, the portion of pipette tip 24 containing stage 228 may be entirely formed from the light transmissive material. For example, the entire cylindrical wall of middle portion 34 may be formed from a light transmissive material, whereas end portion 32 and end portion 36 are formed from other, not necessarily light transmissive materials or whereas end portion 32 and/or end portion 36 may have surface shapes, textures or the like that impede the transmission of light. In other implementations, and in the example illustrated, an entirety of pipette tip 24 is formed from the same light transmissive material, wherein at least those portions of pipette tip 24 that are proximate to one of stages 228 are sufficiently smooth and clear for the transmission of light.

As further shown by FIG. 6, such SEL stages 228 may differ from one another. In the example illustrated, SEL stage 228A presents an arcuate or circumferential platform 250 along the interior 251 of pipette tip 24. In contrast, SEL stage 228C presents a flat platform 254 along the interior 251 of pipette tip 24. As discussed above, in some implementations, such stages 228 may be mounted to the interior of wall 246 by adhesives, welding or the like. In other implementations, such stages 228 may be integrally formed or molded as part of tubular wall 246 of pipette tip 24.

Focusing lenses 242 comprise lenses to focus light from a light source onto one of stages 228, either concentrating or dispersing light rays. In the example illustrated, lenses 242 concentrate light rays onto stages 228. In the example illustrated, lenses 242A-242D concentrate light rays onto stages 228A-228D, respectively. In the example illustrated, each of stages 242 is mounted to the exterior surface of tube 246 opposite to its respective stage 228. For example, to stages 242 may be welded, adhesively bonded or otherwise joined to the exterior of tube 246. Each of lenses 242 has an outer convex surface facing away from the centerline 245 of pipette tip 24. In one implementation, each of lenses 242 is formed from the same material as tubular wall 246. In other implementations, lenses 242 may be formed from other materials such as glass, polypropylene, polystyrene, polymethylmethacrylate.

FIGS. 7-9 illustrate examples of other lenses for use with stages 228 of SPT 220. As shown by FIG. 7, SPT 220 may comprise lenses 252A and 252D (collectively referred to as lenses 252) in place of lenses 242A and 242D, respectively. Lenses 252 are similar to lenses 242 except that lenses 252 are mounted to the interior surface of 246 opposite to a respective stage 228. In one implementation, lenses 252 are mounted by being welded, adhesively bonded otherwise joined to the interior of tube 246. Each of lenses 252 has a concave surface facing toward centerline 245 of pipette tip 24. In one implementation, each of lenses 252 is formed from the same material as tubular wall 246. In other implementations, lenses 252 may be formed from other materials such as glass, polypropylene, polystyrene, polymethylmethacrylate.

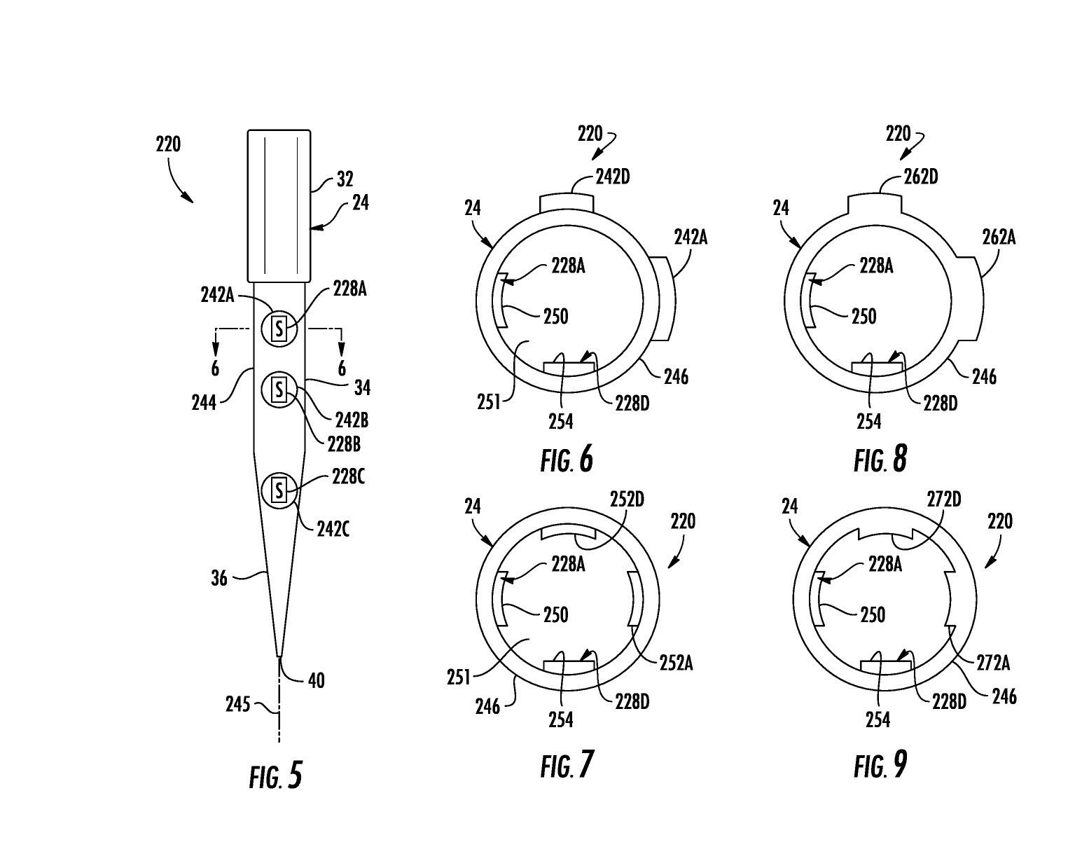

As shown by FIG. 8, SPT 220 may comprise focusing lenses 262A and 262D (collectively referred to as lenses 262) in place of lenses 242A and 242D, respectively. Lenses 262 are similar to lenses 242 except that lenses 262 are integrally formed as a single unitary body with tubular wall 246 along the exterior of tubular wall 246. In one implementation, lenses 262 are formed in the same material as wall 246. In another implementation, lenses 262 are co-molded with wall 246.

As shown by FIG. 9, SPT 220 may comprise focusing lenses 272A and 272D (collectively referred to as lenses 272) in place of lenses 242A and 242D, respectively. Lenses 272 are similar to lenses 252 except that lenses 272 are integrally formed as a single unitary body with tubular wall 246 along the interior of tubular wall 246. In one implementation, lenses 272 are formed in the same material as wall 246. In another implementation, lenses 272 are co-molded with wall 246.

Graduations 244 comprise marks indicating level or quantity of liquid or solution contained within the pipette tip 24. In one implementation, graduations 244 are integrally formed as part of a single unitary body with the outer wall 246 of pipette tip 24, comprising grooves or ribs projecting into or projecting outwards from wall 246. In other implementations, graduations 244 may be printed on pipette tip 24. In other implementations, graduations 244 may be omitted.

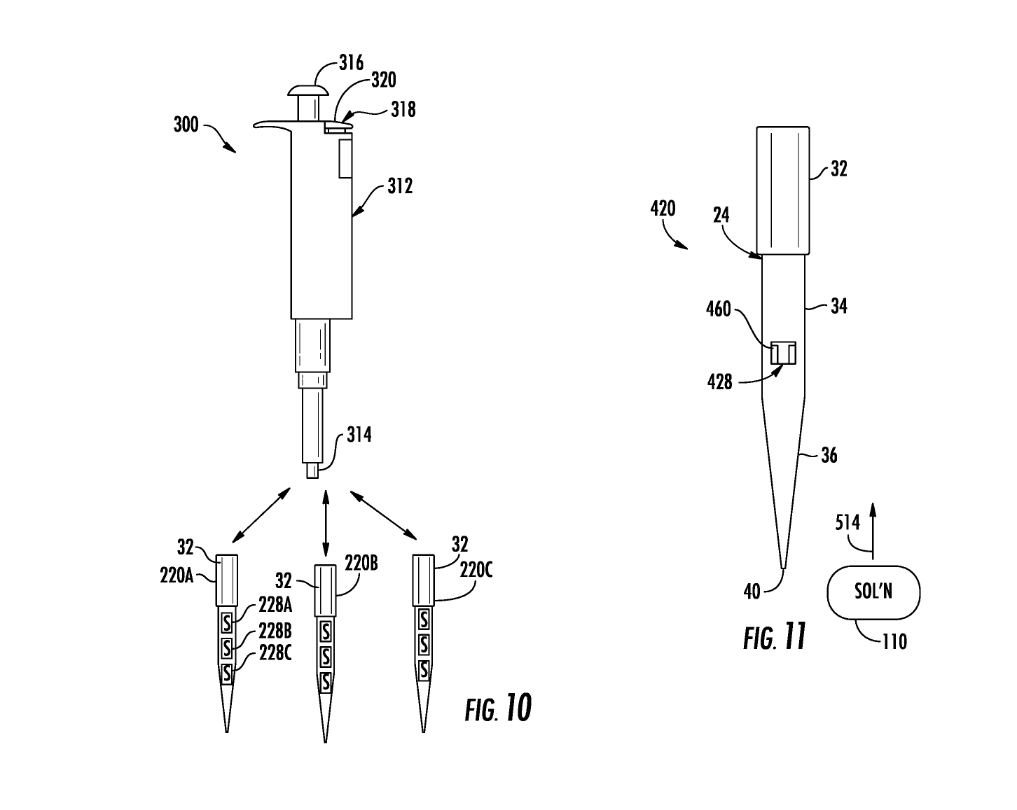

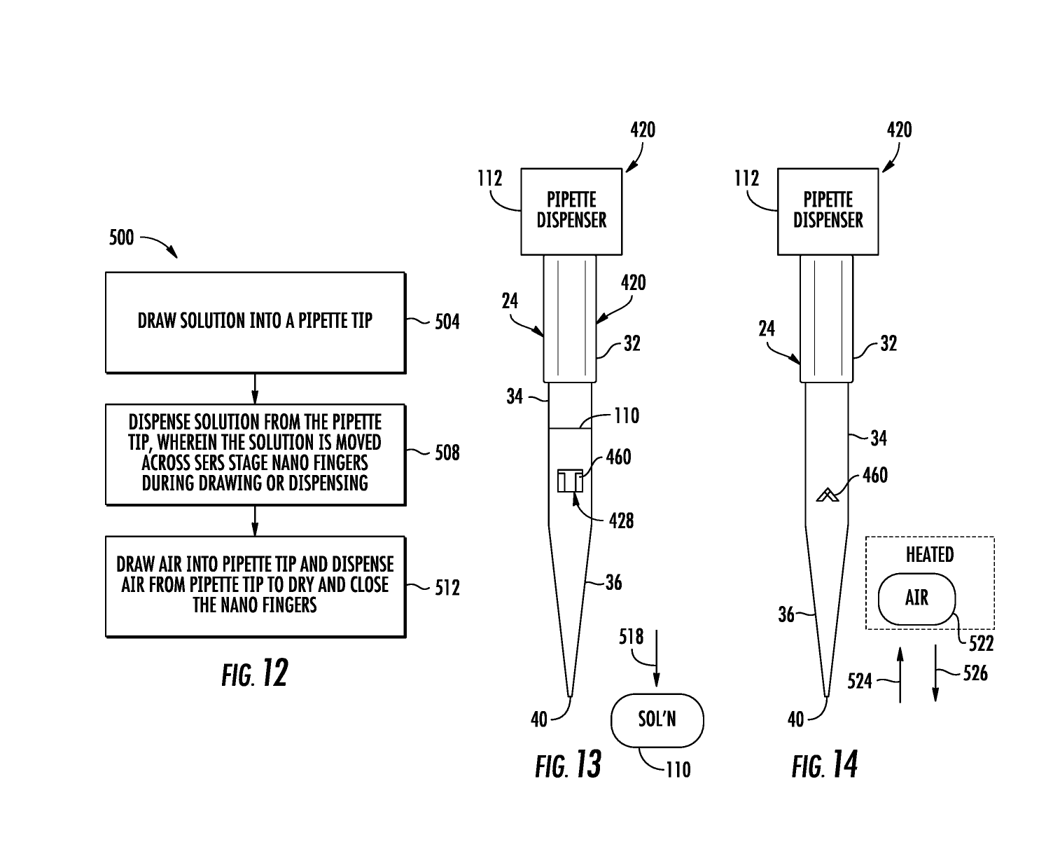

FIG. 10 illustrates an example pipette system 300. Pipette system 300 comprises an example pipette dispenser 312 and a set of different SPTs 220A, 220B, 220C (collectively referred to as SPTs 220). Pipette dispenser 312 comprises a manual handheld dispenser or pipettor having an end portion 314 for being press-fit within end portion 32 of each of SPTs 220 and a manually actuated plunger 316 for aspirating fluid into one of attached SPTs 220 and for expelling or dispensing fluid out of the attached one of SPTs 220. In the example illustrated, dispenser 312 additionally comprise a tip ejector 318 having a pushbutton 320 operably coupled to an end face of end portion 32 such that the president of the pushbutton transmits force so as to push off and eject the attached SPT 220. In other implementations, dispenser 312 may have other sizes, shapes and features.

SPTs 220 are each similar to SPT 220 described with respect to FIGS. 5-9 except that each of SPTs 220 provided as part of system 300 has different characteristics amongst the different SPTs 220. In one implementation, each of SPTs 220 has at least one stage 228 that is different from the stages 228 of the other of SPTs 220. For example, in one implementation, SPT 220A may have a stage 228 that is functionalized for a particular analyte or for testing particular characteristics different than the stages 228 of the other SPTs 220. Because each of SPTs 220 may be interchangeably mounted to end portion 314 of dispenser 312, a user may interchange SPTs 220 with one another to test different analytes or to identify or test different characteristics of the same or different analytes.

In some implementations, each of SPTs 220 may individually comprise multiple different stages 228 which have different characteristics from one another. For example, stage 228A of SPT 220A may be functionalized (provided with structural or chemical characteristics) for a specific first analyte while stage 228B is functionalized for a specific second analyte different than the first analyte. Stage 228D (shown in FIGS. 6-9) of SPT 220A may have physical or chemical properties selected to test a first characteristic of an analyte while stage 228C may have different physical or chemical properties selected to test a second different characteristic of the same analyte.

FIG. 11 is a sectional view of an example SPT 420. SPT 420 is similar to SPT 20 except that SPT 420 is specifically illustrated as comprising stage 428. Those remaining components of system 420 which correspond to components of system 20 are numbered similarly. Although not illustrated, in some implementations, SPT 420 may comprise the additional features shown and described with respect to SPT 220 in FIGS. 5-9. For example, SPT 420 may additionally comprise SEL stages, such as SEL stages 228 or additional SEL stages 428. SPT 420 may additionally comprise a focusing lens 242, 252, 262, 272 (described above) for each of the SEL stages. In some implementations, SPT 420 may comprise graduations 244.

SEL stage 428 comprises nano fingers 460 (two of which are schematically shown). Nano fingers 460 comprise columnar structures such as needles, wires, pillars, posts or the like. Nano fingers 460 are arranged in a two dimensional array or an array of multiple clusters of nano fingers, each cluster comprising sets of more closely arranged or spaced nano fingers. In one implementation, each of nano fingers 460 comprises a metal cap or head (such as gold, silver, copper or alloys thereof) upon which analyte may be deposited. In some implementations, such columnar structures are formed from materials and/or are dimensioned so as to bend or flex towards and away from one another in response to applied electric fields. In some implementations, the nano fingers 460 are movable and are self-actuating, wherein such columnar structures bend or flex towards one another in response to micro-capillary forces such as those occurring during evaporation of solution about such nano fingers 460 so as to close towards one another to self-organize, wherein such bending facilitates close spacing between the structures for greater scattered radiation intensity. In one implementation, adjacent nano fingers 460 are spaced from one another by a distance of at least 10 nm and no greater than 1 micron. In other implementations, the spacing of adjacent nano fingers 460 may vary depending upon the size of the particles or molecules of the analyte to be captured between the nano fingers that close towards one another.

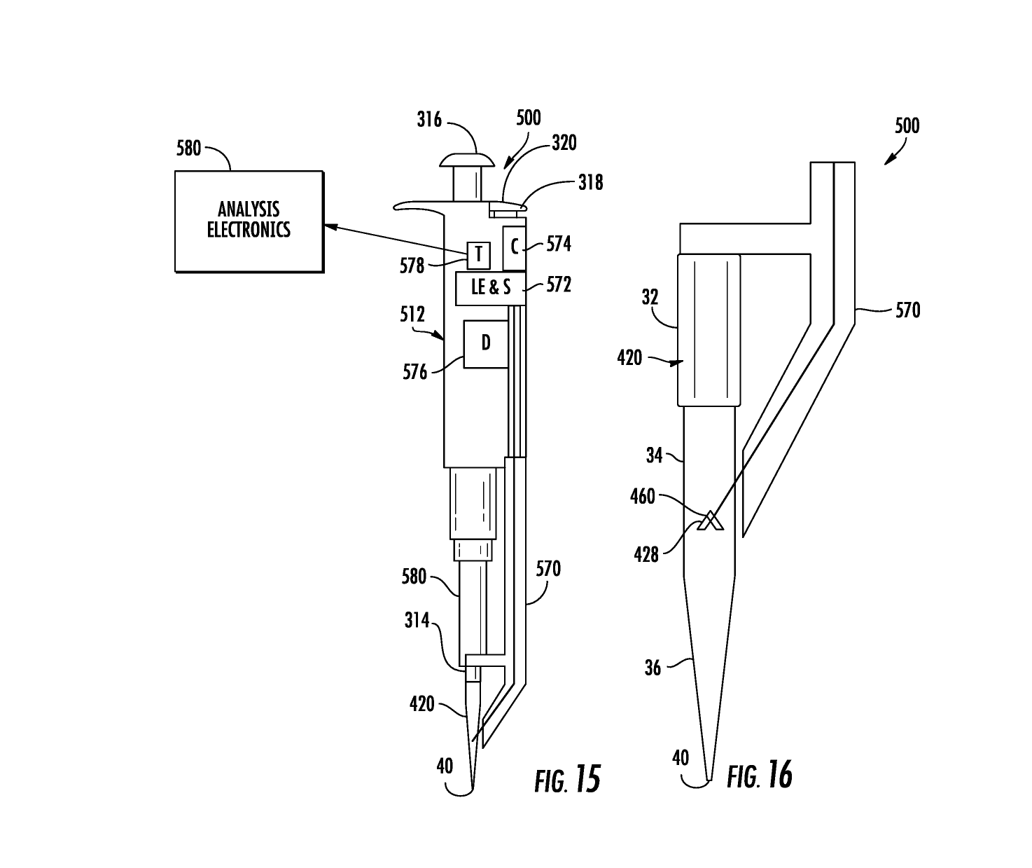

FIG. 12 is a flow diagram of an example method 500 for using SPT 420 to prepare a solution for testing. FIGS. 13 and 14 illustrate method 500 being carried out. Although method 500 is described with respect to SPT 420, it should be appreciated that method 500 may be carried out using other SPTs having nano fingers 460.

As indicated by block 504 in FIG. 12, a solution 110 is drawn into pipette tip 24 of SPT 420, in the direction indicated by arrow 514 until the solution within the interior pipette tip 24 rises above or passes stage 428. In the example illustrated, the solution is drawn using the example pipette dispenser 112 (schematically illustrated). Pipette dispenser 112 may comprise pipette dispenser 312 described above or other pipette dispensers.

As indicated by block 508 in FIG. 12 and also illustrated in FIG. 13, the solution 110 within the interior pipette tip 24 is dispensed or expelled from pipette tip 24 through port 40 and the direction indicated by arrow 518. Once again, solution 110 flows past and across stage 428. Solution 110 thoroughly covers and wets nano fingers 460 of stage 428.

As indicated by block 512 in FIG. 12 and illustrated by FIG. 14, port 40 is withdrawn from the receiver and air 522 is drawn into pipette tip 24 and dispensed from pipette tip 24 as indicated by arrows 524 and 526. In one implementation, air is drawn into and expelled from the interior pipette tip 24 through port 40 by movement of a plunger of this answer 112. In other implementations, air is moved through pipette tip 24, the air being drawn into pipette tip 24 at end portion 32 and be expelled through port 40. As indicated by broken lines, in some implementations, air 522 may comprise heated air, air at a temperature greater than the surrounding environment or ambient temperature, and at a temperature sufficiently high to further accelerate evaporation of the solution 110 wetting the surfaces of nano fingers 460.

In some implementations, air 522 may be drawn into and expelled from the interior of pipette tip 24 multiple times, moving air across stage 428 multiple times. For example, in some implementations, the plunger the princesses plunger 316 of dispenser 312) may be pushed and withdrawn multiple times, wherein the air flow across stage 428 accelerates evaporation of the solution on stage 428 and the closing of nano fingers 460. As shown by FIG. 14, upon sufficient evaporation of the remaining solution within pipette tip 24, nano fingers 460 close towards one another so as to capture particles or analyte for illumination and sensing.

Once nano fingers 460 have captured particles or analyte between their closer ends, SPT 420 is ready for sensing. During sensing, radiation, such as light, is directed at nano fingers 460 of stage 428. The light illuminating stage 428 interacts with the captured particles or analyte. For example, with spec to SERS, the light scatters. The scattered light (or reflected light) is captured and sensed by a light sensor. Signals from the light sensor, based on the sensing of the scattered or reflected light, are used to analyze solution or the analyte.

FIGS. 15 and 16 illustrate an example pipette sensing system 500. In system 500 comprises SPT 420 (described above) and pipette dispenser 512. Pipette dispenser 512, sometimes referred to as a pipettor, is similar to dispenser 312 described above except that dispenser 512 additionally comprises light guide 570, light emitter and sensor 572, controller 574, display 576 and transmitter 578.

Light guide 570, shown in more detail in FIG. 16, comprises optics that optically couple stage 428 to light emitter and sensor 572. In the example illustrated, light guide 570 is mounted to and supported by the lower tubular portion 580 of dispenser 512 so as to extend and terminate adjacent to a side of SPT 420 when SPT 420 is mounted to portion 314 of dispenser 512. Light guide 570 is sufficiently spaced from the mounted SPT 420 such that SPT 420 may be removed from and portion 314 and replaced with another SEL pipette tip. In one implementation, light guide 570 comprises a light transmitting acrylic. In other implementations, light guide 570 may comprise other light transmitting materials forming a light guide or light pipe between stage 428 and light emitter and sensor 572.

Light emitter and sensor 572 (schematically illustrated) comprises a device, carried by dispenser 512, that emits light and directs light along light guide 570 so as to illuminate the closed nano fingers 460 of stage 428. Light emitter and sensor 572 further comprises a device that captures and senses light from stage 428, transmitted along light guide 570. In one implementation, light emitter and sensor 572 comprises an optical sensor or photosensor.

Controller 574 comprises a processing unit that controls the operation of light emitter and sensor 572. In one implementation, controller 574 additionally analyzes signals from light emitter and sensor 572 to determine characteristics of the analyte upon stage 428. In such an implementation, controller 574 outputs results of such analysis on display 576. Display 576 comprises a display device, such as an LED screen or one or more light emitting diodes carried by dispenser 512. In some implementations, display 576 may be omitted.

In some implementations, such as implementation where display 576 is omitted, controller 574 may outsource the analysis of signals from light emitter and sensor 572. In such an implementation, controller 574 may output signals via transmitter 578 to external analysis electronics 580. For example, in one implementation, transmitter 578 may transmit such signals from light emitter sensor 572, in a wired or wireless fashion, to analysis electronics. The analysis electronics 580 may be embodied as part of a portable electronic device such as a notebook computer, tablet computer or smart phone. The analysis electronics may be embodied or incorporated into a desktop computer or processors associated with a server, wherein such analysis electronics provide cloud-based analysis of signals from light emitter and sensor 572.

FIG. 17 is a flow diagram of an example method 600 for controlling the operation of a light emitter and sensor, such as light emitter and sensor 572. As indicated by block 604, controller 574 detects movement of a manual actuator dispenser 512. In one implementation, controller 574 detects movement of plunger 316. In another implementation, controller 574 detects initial movement of pushbutton 320 of ejector 318.

As indicated by block 608, in response to detected movement of the manual actuator, controller 574 automatically outputs control signals initiating the emission of light by light emitter and sensor 572. Controller 574 further outputs control signals initiating the SEL sensing. Upon receipt of such signals, controller 574 itself or external analysis electronics 580 determine characteristics of the analyte based upon such signals.

Sensing system 500 carries out sensing of the analyte on stage 428 while SPT 420 remains attached to dispenser 512. However, in other implementations, the SPT 20, 220, 420 may be utilized with a pipette dispenser similar to pipette dispenser 112, wherein the SPT is detached from the pipette dispenser for sensing independent of the pipette dispenser. By performing independent sensing of the pipette tip, the complexity and cost of the pipette dispenser may be kept relatively low. Moreover, a single dispenser, such as dispenser 112, may be repeatedly used with different SPTs without delays brought about by sensing of the individual SPTs.

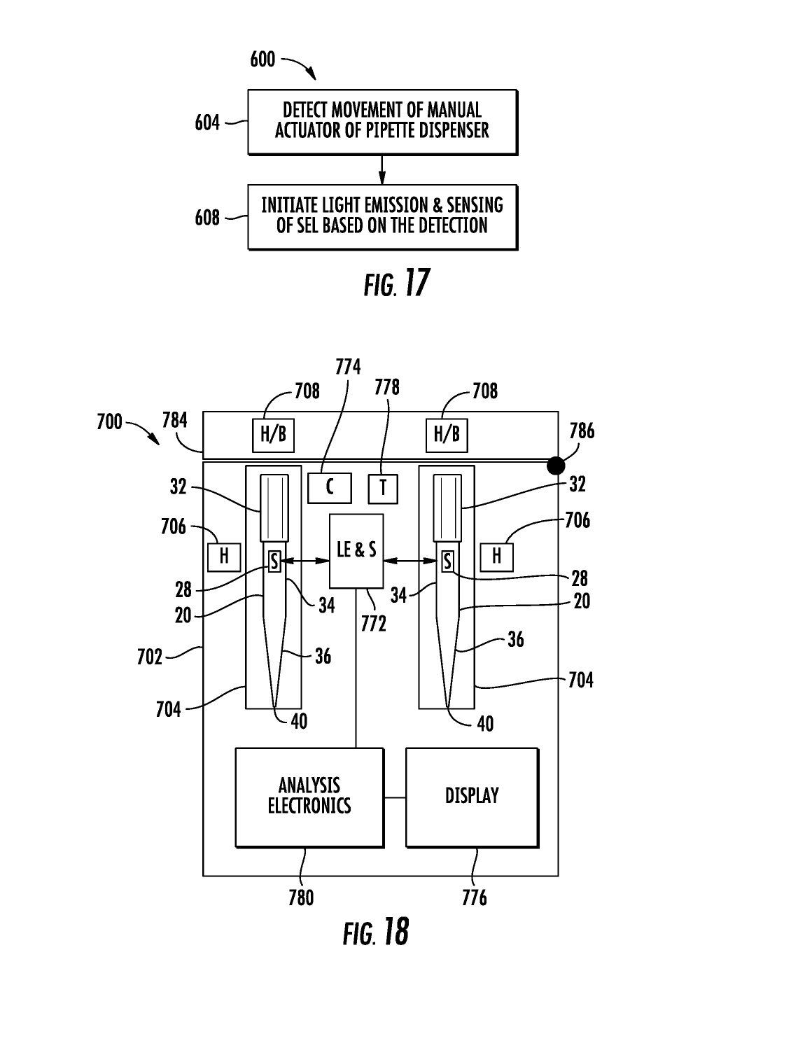

FIG. 18 illustrates an example sensing station 700 for sensing multiple SPTs. Sensing station 700 comprises housing 702, pipette retainers 704, heaters 706, heaters and/or blowers 708, light emitter and sensor 772, controller 774, display 776, transmitter 778 and analysis electronics 780. Housing 702 encloses it to the aforementioned components of sensing station 700 as a single unit.

Pipette retainers 704 comprise structures that hold and retain individual SEL pipette tips 20, 220, 420 for sensing. In the example illustrated, retainers 704 each comprise cavities or wells into which SPTs are dropped or received. In other implementations, pipette retainers 704 may comprise clips, clamps or the like for holding and retaining SPTs in a defined orientation, properly aligning the stage or stages of such SPTs with the optical coupling to light emitter and sensor 772. Although FIG. 18 illustrates wells of retainer 704 receiving SPTs 20, in other implementations, other SPTs may be received within the wells of retainer 704.

In one implementation, each of the wells serving as retainer 704 has a depth or is otherwise tapered so as to retain the received SPT 20 at a height or vertical position such that stage 428 is vertically aligned with optics for being operably coupled to light emitter and sensor 772. In one implementation, end portion 32 of the SPTs are asymmetric or otherwise uniquely shaped, whereas at least the mouth of the wells of retainer 704 have corresponding asymmetric shapes or otherwise uniquely shaped openings to define and control the rotational positioning of each SPT 20 into a well to facilitate alignment of the stage or stages of the SPT with the optical components or light guides of light emitter and sensor 772.

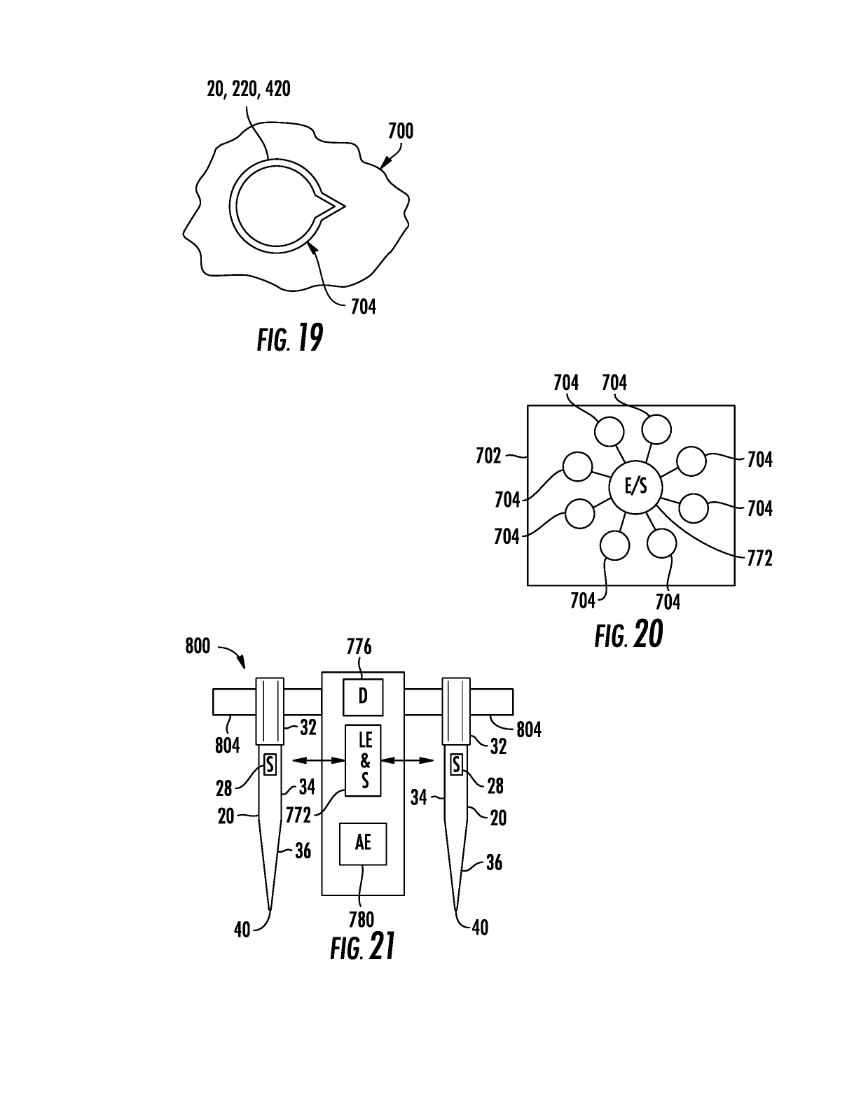

FIG. 19 illustrates one example of such keying of SPTs 20, 220, 420 into the wells of retainer 704 to facilitate proper alignment of the stages of the SPTs with the stage illuminating optics of station 700. In other implementations, other keying arrangements may be used. It still other implementations, alignment indicia may be provided on each of pipette tips 24 of the SPTs and portions of housing 702 and to the openings of each of retainer 704, wherein the user is instructed to align the indicia to align the stages 28 with respect to the light guides or light emitter and sensor 772.

Heaters 706 comprise devices within housing 702 adjacent to retainer 704 so as to emit and apply heat to stages 28 while the SPTs 20 are received and retained by retainer 704. Heaters 706 accelerate the evaporation of the solution on stages 28. In one implementation, heater 706 comprises electrical resistors which emit heat in response to the application of electrical current. In some implementations, heater 706 may comprise other types of heaters or may be omitted.

Heaters and/or blowers 708 comprise devices that blow air at ambient temperature or heated air through the interior of SPTs 20 retained by retainer 704. In one implementation, housing 702 comprises a closable lid portion 784, pivotable about a hinge 786. Lid portion 784 carries the heaters and/or blowers 708, wherein such heaters and/or blowers 708 are positioned in alignment with the opening mouth of end portion 32 of each of the retained SPTs 20 when the lid is closed. Such alignment facilitates the directing of the air or heated air through the interior of each of the SPTs 20 to accelerate drying of the analyte on the various stages of the SPTs 20. In implementations where stage 28 comprises nano fingers, such drying accelerates closing of nano fingers 460. In other implementations, heaters and/or blower 708 may be omitted, such as where such a drying of the SPTs occurs without assistance in retainer 704 or is achieved prior to the positioning of the SPTs in station 700.

Light emitter and sensor 772, controller 774, display 776, transmitter 778 and analysis electronics 780 are similar to light emitter and sensor 572, controller 574, display 576, transmitter 578 and analysis electronics 580 described above. Light emitter and sensor 772 is operably coupled to the stages of SPTs by light guide when such SPTs are received within station 700. Light emitter and sensor 772 may concurrently illuminate each of the stages 28 of the SPTs 20 and may concurrently receive light resulting from the interactions with the analyte on the stages 28. Signals from the sensing portion of light emitter and sensor 772 are transmitted to electronics 780 which displays the results on display 776. In one implementation, the signals from light emitter and sensor 772 may also be transmitted by transmitter 778, in a wired or wireless fashion, to remote analysis electronics, such as analysis electronics 580 described above. In some implementations, transmitter 778 may transmit, in a wired or wireless fashion, the results of such analysis output by analysis electronics 780.

FIG. 20 is a top view schematically illustrating one example layout of retainers 704 for sensing station 700, wherein multiple retainer 704, multiple wells (and multiple received SPTs) share a central light emitter and sensor 772. In other implementations, each of retainers 704 may have a dedicated light emitter and sensor 772.

FIG. 21 illustrates another example sensing station 800. Sensing station 800 is similar to sensing station 700 except that sensing station 800 comprises SPT retainers 804. Retainers 804 comprise wings or arms that clip or clamp about end portion 32 of SPTs 20, positioning their respective stages 28 opposite to, across and in alignment with the light emitter (laser) and the light sensor of light emitter and sensor 772. In one implementation, retainers 804 may be arranged in a similar layout as that shown in FIG. 20. Although station 800 is illustrated as retaining multiple SPTs 20, station 800 may likewise be utilized with SPTs 220, 420 described above or other SPTs.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. An apparatus comprising:
a pipette tip having a first end portion to releasably mount to a pipette dispenser and a second end portion that is tapered;
a surface enhanced luminescence (SEL) stage on an interior of the pipette tip.

2. The apparatus of claim 1, wherein the SEL stage comprises a surface enhanced Raman spectroscopy (SERS) stage.

3. The apparatus of claim further comprising:
a pipette dispenser coupled to the pipette tip;
a light emitter carried by the pipette dispenser and optically coupled to the SEL stage; and
a light sensor carried by the pipe dispenser and optically coupled to the SEL stage.

4. The apparatus of claim 3 further comprising analysis electronics carried by the pipette dispenser to analyze signals from the light sensor.

5. The apparatus of claim 3, wherein the pipette dispenser comprises a manual actuator to initiate at least one of aspiration and dispensing of solution from the pipette tip, wherein the light emitter is triggered in response to actuation of manual actuator.

6. The apparatus of claim 3 further comprising a transmitter carried by the pipette dispenser to transmit data signals, output by the light sensor, to analysis electronics.

7. The apparatus of claim 1 further comprising a sensing station, the sensing station comprising:
a pipette retainer removably receiving the pipette tip;
a light emitter to be optically coupled to the SEL stage to impinge the SEL stage of the received pipette tip with light; and
a light sensor to be optically coupled to the SEL stage to receive reflected light from the SEL stage in the received pipette tip.

8. The apparatus of claim 1 further comprising a second SEL stage on an interior of the pipette tip.

9. The apparatus of claim 1 further comprising:
a second pipette tip interchangeable with the first pipette tip;
a second SEL stage within the second pipette tip, wherein the SEL stage is functionalized for a first analyte and wherein the second SEL stage is functionalized for a second analyte different than the first analyte.

10. The apparatus of claim 1, further comprising a focusing lens carried by the pipette tip proximate the SEL stage.

11. A method comprising:
drawing a solution into a pipette tip; and
dispensing a solution from the pipette tip, the solution containing an analyte, wherein the solution is moved across a SEL stage within the pipette tip during at least one of the drawing of the solution and the dispensing of the solution.

12. The method of claim 11 further comprising:
directing light at the analyte on the SEL stage;
sensing light interactions with the analyste on the SEL stage; and
analyzing the solution based on the sensing of the light interactions.

13. The method of claim 11 further comprising accelerating drying of the solution on the SEL stage in the pipette tip.

14. The method of claim 11 further comprising:
removing the pipette tip from a pipette dispenser; and
positioning the removed pipette tip in a pipette tip retainer of a sensing station;
directing light at the analyte on the SEL stage of the pipette tip retained by the pipette tip retainer;
sensing light interactions with the analyte on the SEL stage; and
analyzing the solution based on the sensing of the light interactions.

15. A sensing station comprising:
a pipette tip retainer to retain at least a portion of a pipette tip containing a SEL stage;
a light emitter to direct light at the SEL stage within a retained pipette tip; and
a light sensor to receive light from the SEL stage within the retained pipette tip.
